(19) United States
(12) Patent Application Publication
(10) Pub. No.: US 2017/0060517 A1
(43) Pub. Date: Mar. 2, 2017

(54) INFORMATION PROCESSING SYSTEM

(71) Applicant: Ryoh SHIMOMOTO, Kanagawa (JP)

(72) Inventor: Ryoh SHIMOMOTO, Kanagawa (JP)

(73) Assignee: Ricoh Company, Ltd., Tokyo (JP)

(21) Appl. No.: 15/038,784

(22) PCT Filed: Jan. 14, 2015
(86) PCT No.: PCT/JP2015/051431

§ 371 Date: May 24, 2016

(30) Foreign Application Priority Data
Jan. 17, 2014 (JP) 2014-007277
Jan. 6, 2015 (JP) 2015-000719

(51) Int. Cl. G06F 3/14; H04L 12/58; G06F 3/0484

(52) U.S. Cl. CPC G06F 3/1454; G06F 3/04842; H04L 51/22; G06F 2203/04803

(57) ABSTRACT

An information processing system includes first and second terminal devices. The first terminal device includes an acquisition unit acquiring a file from an information processing apparatus connected to the information processing system, a first display unit having a first display area displaying the file and a second display area displaying messages from the second terminal device, a reception unit receiving a selection of a certain area of the file, and a transmission unit transmitting a message including information indicating the certain area to the second terminal device. The second terminal device includes a second display unit including similar first and second display areas, and displaying the message, including the information indicating the certain area from the first terminal device, in the first display area, and, upon receiving a selection of the displayed message, displays the file based on the information indicating the certain area included in the displayed message.

### TECHNICAL FIELD

The present invention relates to an information processing system.

### BACKGROUND ART

There has been known a group messaging system that can perform group file management using a messenger by reporting an occurrence of an activity via a group chat room of the messenger mapped to a shared group in a case where, for example, an activity occurs such as file registration relative to a file managed in the shared group by a Cloud server by simultaneously operating a messenger server and the Cloud server (see, for example, Patent Document 1).

### SUMMARY OF THE INVENTION

### Problems to be Solved by the Invention

A user may perform file sharing among a plurality of users by using an information processing apparatus such as a file server that can perform file sharing among the users. Further, a user may perform sharing by exchanging comments on a file using an information processing apparatus such as a chat server among the users who perform the file sharing.

However, there has been no scheme available to coordinate (cooperate, work) a function of the file sharing with a function of exchanging comments on the file in a terminal device that performs the file sharing and exchanges comments on the file among the users.

An embodiment of the present invention is made in light of this point (problem), and may provide an information processing system capable of coordinating the function of file sharing and the function of exchanging comments on the file to work together.

### Means for Solving the Problems

According to an aspect of the present invention, an information processing system includes one or more information processing apparatuses; and two or more terminal devices, including first and second terminal devices, which are connected to the one or more information processing apparatuses. Further, each of the information processing apparatuses includes a storage unit storing a file, and a first transmission unit transmitting, in response to a request from one of the terminal devices, the file stored in the storage unit to the one of the terminal devices. Further, the first terminal device includes an acquisition unit sending the request to the one or more information processing apparatuses to acquire the file stored in the storage unit, and acquiring the file, a first display unit including first and second display areas, the first display area displaying the file acquired by the acquisition unit, the second display area displaying messages transmitted to and received from the second terminal device, a reception unit receiving a selection of a certain area of the file displayed in the first display area by the first display unit and an operation to transmit the certain area as one of the messages transmitted to and received from the second terminal device, and a second transmission unit transmitting a message, which includes information indicating the certain area received by the reception unit, to the second terminal device. Further, the second terminal device includes a second display unit including first and second display areas, the first display area displaying the file, the second display area displaying messages transmitted to and received from the first terminal device. Further, the second display unit displays the message, which includes the information indicating the certain area and is transmitted from the first terminal device, in the first display area, and, upon receiving a selection of the displayed message, displays the file based on the information indicating the certain area included in the displayed message.

### Effects of the Present Invention

According to an aspect of the present invention, it becomes possible to coordinate a function of file sharing and a function of exchanging comments on the file to work together.

### BRIEF DESCRIPTION OF THE DRAWINGS

FIG. 1 is a drawing illustrating an example configuration of an information processing system according an embodiment of the present invention;

FIG. 2 is a drawing illustrating an example hardware configuration of a computer according to an embodiment of the present invention;

FIG. 3 is a processing block diagram of an example smart device according to an embodiment of the present invention;

FIG. 4 is a processing block diagram of an example chat server according to an embodiment of the present invention;

FIG. 5 is a processing block diagram of an example relay server according to an embodiment of the present invention;

FIG. 6 is a processing block diagram of an example file server according to an embodiment of the present invention;

FIG. 7 is a conceptual drawing of an example Web UI illustrating a two-dimensional code;

FIG. 8 is a conceptual drawing of an example screen to read the two-dimensional code;

FIG. 9 is a drawing illustrating an example configuration of information acquired from the two-dimensional code;

FIG. 10 is a flowchart of an example of a smart device registration process;

FIG. 11 is a conceptual drawing of an example screen when registration is successful;

FIG. 12 is a sequence diagram of an example of a group generation process;

FIG. 13 is a conceptual drawing of an example of a group generation screen;

FIG. 14 is a conceptual drawing of an example of a group selection screen to perform chatting;

FIG. 15 is a conceptual drawing of an example of a chat screen;

FIG. 16 is a conceptual drawing of an example of a file selection screen;

FIG. 17 is a conceptual drawing of an example of the chat screen displaying a content of a file;

FIG. 18 is a flowchart of an example of a range selection operation;

FIG. 19 is a conceptual drawing of an example of a process to proceed to step S22;

FIG. 20 is an example sequence diagram when a start point of the range selection operation is on an image;

FIG. 21 is a drawing illustrating an example configuration of image positional information;

FIG. 22 is a conceptual drawing of an example of a process to proceed to step S23;

FIG. 23 is an example sequence diagram when the start point of the range selection operation is on a character string;

FIG. 24 is a drawing illustrating an example of character string information;

FIG. 25 is s sequence diagram of a process when a character string, which is displayed as hyperlink in a chat area, is selected; and

FIG. 26 is a drawing illustrating a process performed by a smart device when a user selects information (message) of the chat area;

FIG. 27 is a drawings illustrating an example screens when the smart device opens a file different from a file indicated by meta data; and

FIG. 28 is a drawing of another example of the information processing apparatus according to an embodiment.

### BEST MODE FOR CARRYING OUT THE INVENTION

Next, embodiments of the present invention are described in detail.

### First Embodiment

### System Configuration

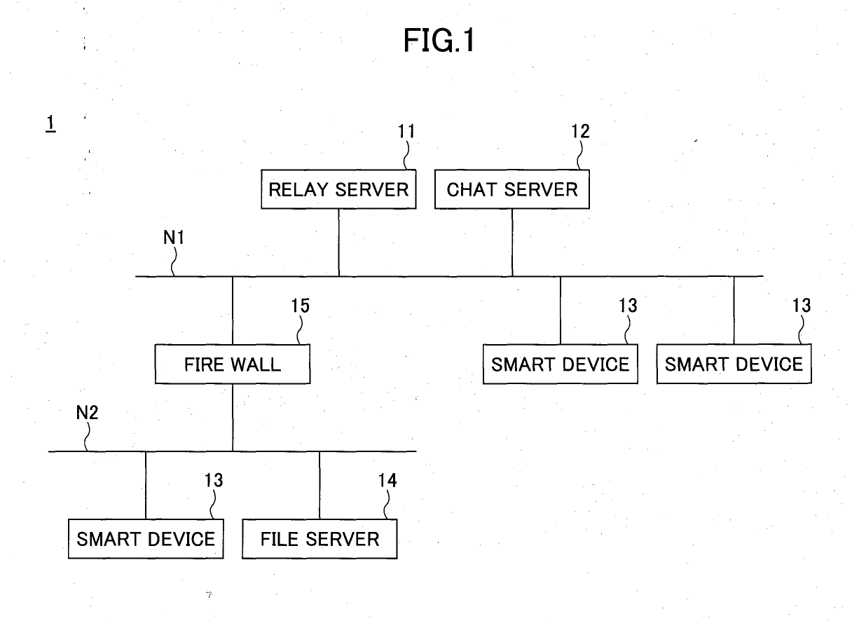

FIG. 1 illustrates an example configuration of an information processing system according to this embodiment. An information processing system 1 of FIG. 1 includes a relay server 11, a chat server 12, smart devices 13, a file server 14, and a firewall (FW) 15.

The relay server 11, the chat server 12, and at least a part of the smart devices 13 are connected with a network N1 such as the Internet. Further, the file server 14 and at least a part of the smart devices 13 are connected with a network N2 such as a

Local Area Network (LAN). The network N1 is connected with the network N2 via the FW 15.

The relay server 11 first receives a “request” which is from the chat server 12 and the smart device 13, which are connected to the network N1, to the file server 14 which is connected to the network N2, and relays (outputs) the request to the file server 14.

The chat server 12 receives conversation content, etc., from the smart devices 13 to perform chatting among the smart devices 13, and distributes the conversation content, etc. The smart device 13 refers to a terminal device which is used by a user.

In the file server 14, for example, a file shared by the users and the logs of the conversation content of the conversations performed by the users are stored. The file server 14 is connected to the network N2. Therefore, it is not possible for the relay server 11, the chat server 12, and the smart devices 13 which are connected with the network N1 to directly access the file server 14. It is possible for the file server 14 to indirectly access the relay server 11, the chat server 12, and the smart devices 13 which are connected with the network N1.

The file server 14 constantly (repeatedly) makes an inquiry of the relay server 11 to determine whether to receive the “request”. When determining that the relay server 11 receives the request, the file server 14 acquires the request from the relay server 11 and performs processing on the request. Further, the file server 14 reports a processing result of the request to the relay server 11. The smart device 13, which sends the request, can receive the processing result of the request from the relay server 11. As described, the request from the smart device 13 connected with the network N1 to the file server 14 connected with the network N2 can be transmitted indirectly via the relay server 11.

The relay server 11, the chat server 12, and the smart devices 13, which are connected to the network N1, can communicate with each other. Similarly, the smart devices 13 and the file server 14 which are connected to the network N2 can communicate with each other. In FIG. 1, the smart devices 13 are an example of a terminal device operated by a user. The smart device 13 is a device that can be operated by a user such as a smartphone, a tablet terminal, a cellular phone, a laptop personal computer (PC), etc.

Note that the configuration of the information processing system 1 of FIG. 1 is one example only. Various system configurations depending on applications and purposes may also fall within the scope of the present invention. For example, the relay server 11, the chat server 12, and the file server 14 of FIG. 1 may be distributed among plural computers. Further, the relay server 11 and the chat server 12 may be integrated into a single computer.

### Hardware Configuration

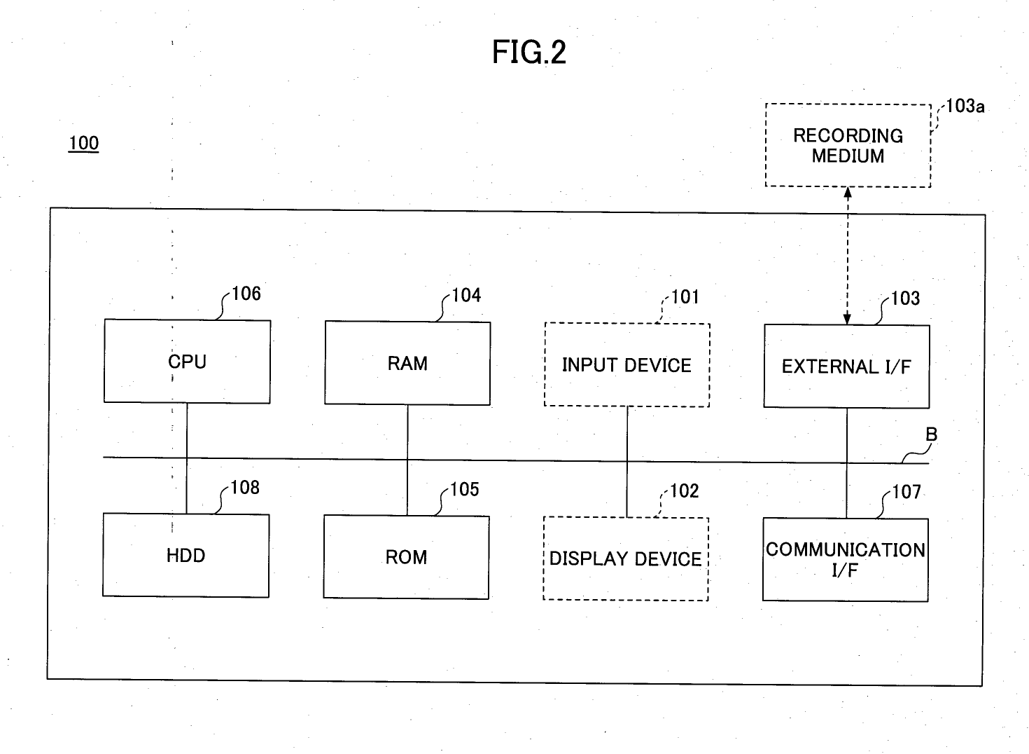

The relay server 11, the chat server 12, and the file server 14 can be realized by a computer that has a hardware configuration as illustrated in FIG. 2. Further, a configuration of the smart device 13 includes the hardware configuration as illustrated in FIG. 2. FIG. 2 is an example hardware configuration of a computer according to an embodiment.

A computer 100 of FIG. 2 includes an input device 101, a display device 102, an external interface (I/F) 103, a Random Access Memory (RAM) 104, a Read-Only Memory (ROM) 105, a Central Processing Unit (CPU) 106, a communication I/F 107, a Hard Disk Drive (HDD) 108, etc., which are mutually connected to each other via a bus B. The input device 101 and the display device 102 may be connected on an as necessary basis.

The input device 101 includes a keyboard, a mouse, a touch panel, etc., and is used to input various operation signals to the computer 100. The display device 102 includes a display, etc., and displays a processing result by the computer 100. The communication I/F 107 is an interface to connect the computer 100 to the networks N1 and N2. Via the communication I/F 107, the computer 100 can perform data communications with another computer 100.

The HDD 108 is a non-volatile storage device storing programs and data. The programs and data stored in the HDD 108 include, for example, an Operating System (OS), which is fundamental software to control the entire computer 100, and application software which provides various functions running on the OS. Further, the HDD 108 manages the programs and the data stored therein based on a predetermined file system and/or database (DB).

The external I/F 103 is an interface with an external device. The external device includes a recording medium 103a, etc. The computer 100 can read and write data from and to the recording medium 103a via the external I/F 103. The recording medium 103a includes a flexible disk, a Compact Disk (CD), a Digital Versatile Disk (DVD), an SD memory card, a Universal Serial Bus (USB) memory, etc.

The ROM 105 is a non-volatile semiconductor memory (storage device) which can hold programs and data stored therein even when power thereto is turned off. In the ROM 105, programs and data such as BIOS, which is executed when the computer 100 starts up, OS settings, network settings, etc., are stored. The RAM 104 is a volatile semiconductor memory (storage device) which temporarily stores programs and data.

The CPU 106 reads (loads) the programs and data from the storage device such as the ROM 105 and the HDD 108.

By having the hardware configuration described above, the computer according to an embodiment can execute various processes described below.

### Software Configuration

### Smart Device

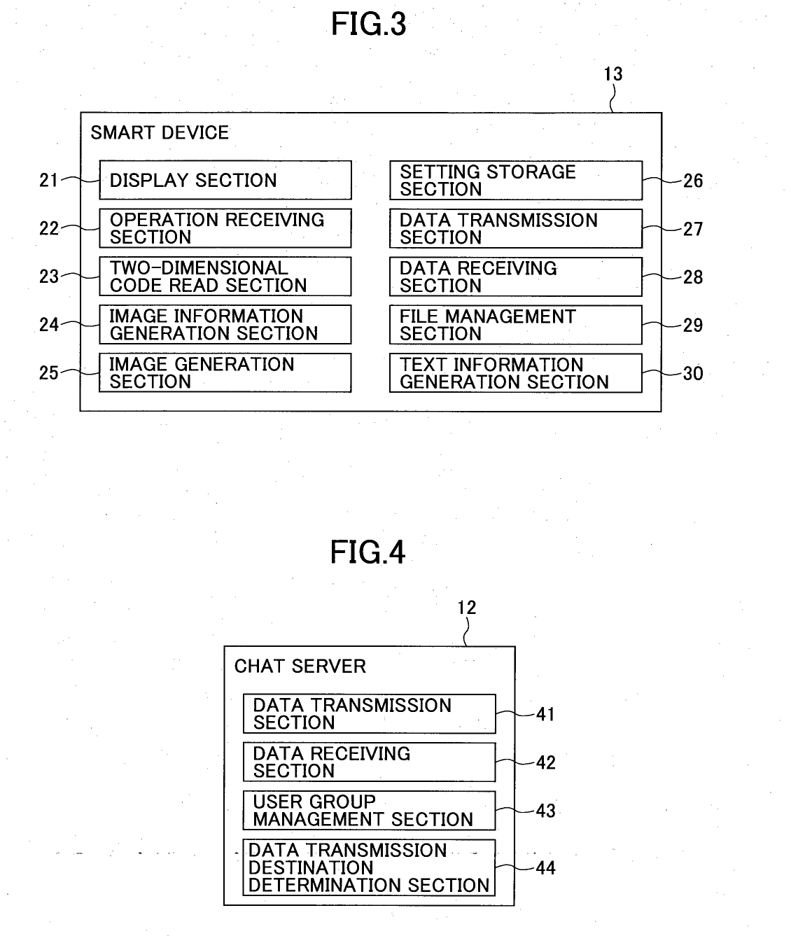

The smart device 13 according to an embodiment can be realized based on, for example, the processing blocks as illustrated in FIG. 3. FIG. 3 is a processing block diagram of an example of the smart device 13 according to an embodiment. The smart device 13 includes a display section 21, an operation receiving section 22, a two-dimensional code read section 23, an image information generation section 24, an image generation section 25, a setting storage section 26, a data transmission section 27, a data receiving section 28, a file management section 29, and a text information generation section 30, which are realized by executing an application program (hereinafter referred to as an “application”).

The display section 21 displays the content of the file, the conversation content of chat, a file selection screen, etc., to a user. The operation receiving section 22 receives an operation from a user. The two-dimensional code read section 23 reads a two-dimensional code.

The image information generation section 24 generates image positional information such as the position and the file name of a partial image selected by a user from an image of the file displayed on the display section 21. The image generation section 25 generates an image based on the image positional information. The setting storage section 26 stores settings such as a user name, a password, a group, etc.

The data transmission section 27 transmits the conversation content of chat, the image positional information, etc. The data receiving section 28 receives the conversation content of chat, the image positional information, the file, etc. The file management section 29 stores and deletes a cache of the received file. The text information generation section 30 generates character string information such as the position of the character string and the file which are selected by a user from among the files displayed on the display section 21.

### Chat Server

The chat server 12 according to an embodiment can be realized by, for example, processing blocks as illustrated in FIG. 4. FIG. 4 is a processing block diagram of an example chat server according to an embodiment of the present invention. The chat server 12 includes a data transmission section 41, a data receiving section 42, a user group management section 43, and a data transmission destination determination section 44, which are realized by executing a program.

The data transmission section 41 transmits data such as conversation content of chat (content of chat conversation). The data receiving section 42 receives data such as conversation content of chat. The user group management section 43 manages users who are participating in chat and a group to which conversation content of chat is to be transmitted. The data transmission destination determination section 44 determines the group to which conversation content of chat is to be transmitted. The chat server 12 provides chat functions.

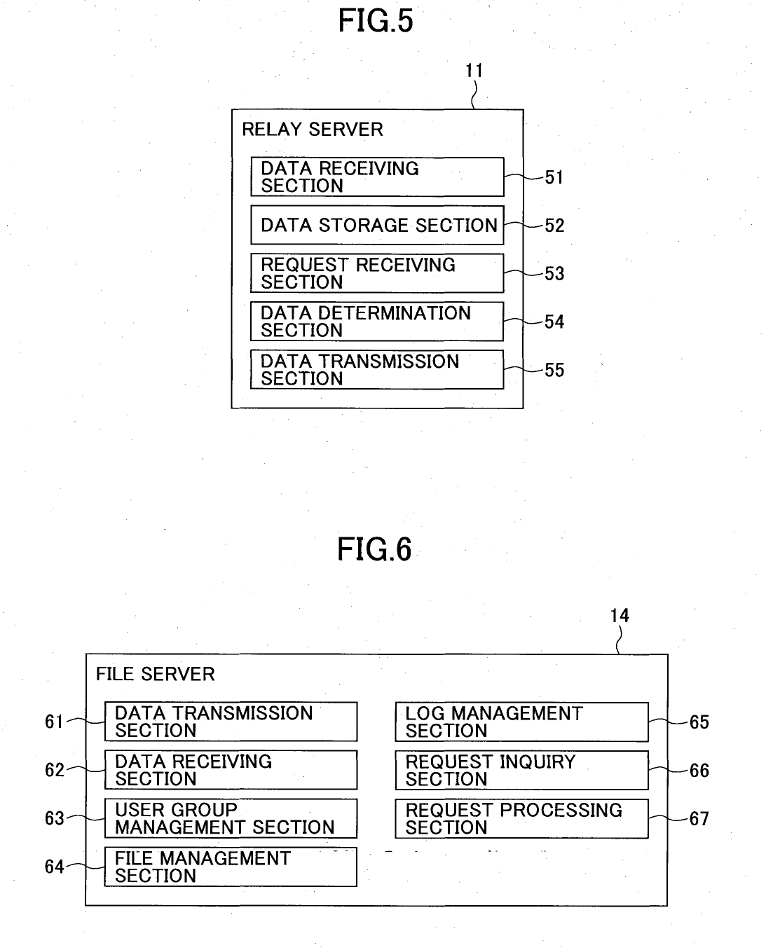

The relay server 11 according to an embodiment can be realized by, for example, processing blocks as illustrated in FIG. 5. FIG. 5 is a processing block diagram of an example relay server 11 according to an embodiment of the present invention. The relay server 11 includes a data receiving section 51, a data storage section 52, a request receiving section 53, a data determination section 54, and a data transmission section 55, which are realized by executing a program.

The data receiving section 51 receives, for example, data from the smart device 13 connected to the network N1, a smart device ID of the transmission source of the data, a file server ID of the transmission destination of the data, etc. The data storage section 52 stores various data, which are received by the data receiving section 51, in an associated manner. The request receiving section 53 receives the inquiry from the file server 14 to determine whether the “request” is received.

The data determination section 54 determines whether there are stored data which are associated with the file server ID of the file server 14 from which the request receiving section 53 receives the inquiry. The data transmission section 55 transmits the stored data to the file server 14 from which the inquiry is received when the data determination section 54 determines that there are stored data.

### File Server

The file server 14 according to an embodiment can be realized by, for example, processing blocks as illustrated in FIG. 6. FIG. 6 is a processing block diagram of an example file server according to an embodiment of the present invention. The file server 14 includes a data transmission section 61, a data receiving section 62, a user group management section 63, a file management section 64, a log management section 65, a request inquiry section 66, and a request processing section 67, which are realized by executing a program.

The data transmission section 61 transmits a file and data such as a processing result of the request. The data receiving section 62 receives data such as a file, a log of conversation content of chat, the request from other smart devices 13, etc. The user group management section 63 manages users who are participating in chat and a group to which conversation content of chat is to be transmitted.

The file management section 64 stores the received file, reads the stored file, etc. The log management section 65 stores a log of conversation content of chat. The request inquiry section 66 queries the relay server 11 to determine whether there exists the request. The request processing section 67 performs processing on the request based on the content of the request.

### Details of Processing

In the following, details of the processing performed by the information processing system 1 according to an embodiment are described.

### Device Registration

In the information processing system 1 according to an embodiment, it is necessary to register the smart devices 13 which are accessible to the file server 14. For example, in the information processing system 1, the smart devices 13 which are accessible to the file server 14 are registered (pairing) by using a two-dimensional code as described below.

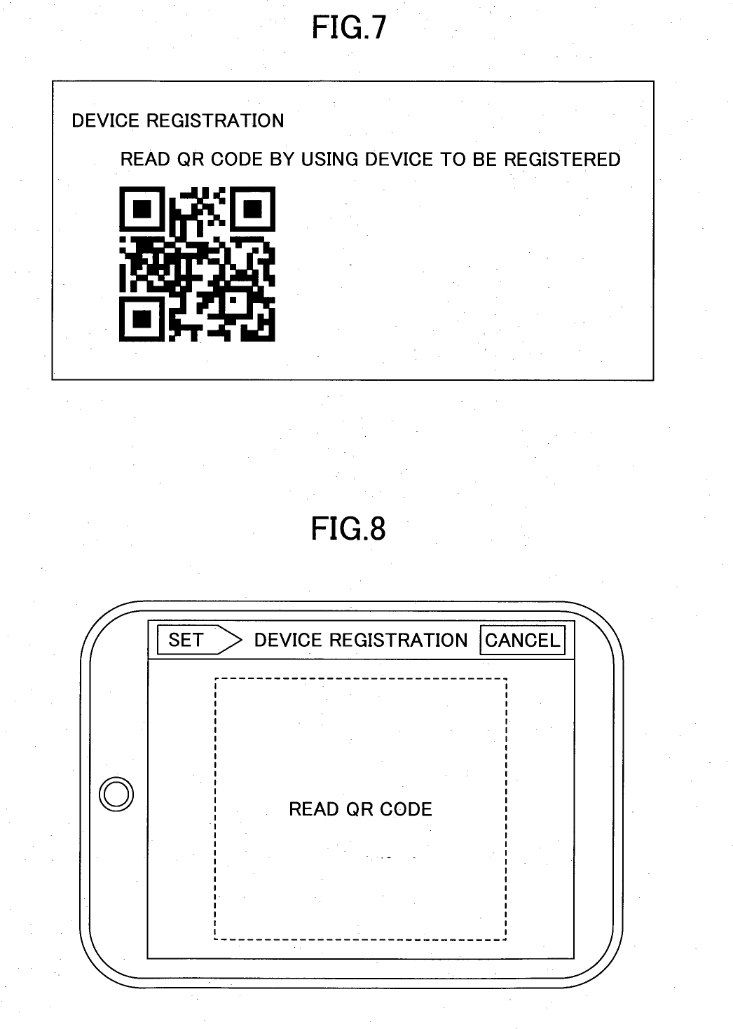

FIG. 7 is a conceptual drawing of an example Web UI displaying a two-dimensional code. As the Web UI of FIG. 7, a two-dimensional code such as QR code (registered trademark) is illustrated. A user causes the smart device 13, which is to be registered as the smart device 13 accessible to the file server 14, to read the two-dimensional code displayed on the Web UI.

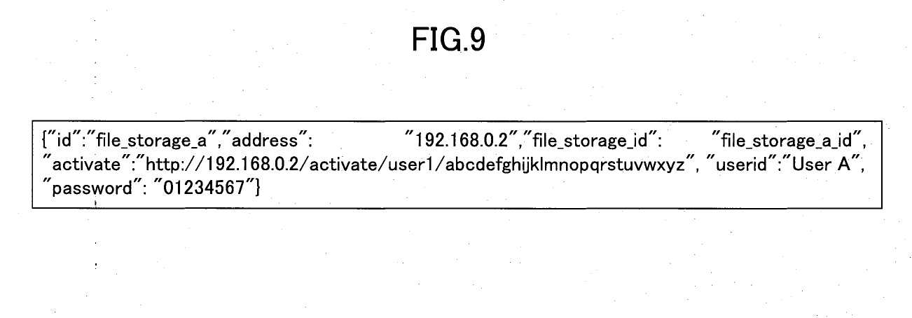

FIG. 8 is a conceptual drawing of an example screen to read the two-dimensional code. A user can cause the smart device 13 to read the two-dimensional code by adjusting the position of the smart device 13 in a manner so that the two-dimensional code, which is imaged by the smart device 13, is displayed inside the dotted lines on the screen of FIG. 8. The registration of the smart device 13 is performed regardless of whether the relay server 11 is used. By reading the two-dimensional code, it becomes possible for the smart device 13 to acquire information, which is necessary to access the file server 14, as illustrated in FIG. 9.

Note that the Web UI of FIG. 7 may be display by accessing an information processing apparatus such as the file server 14 by a user by using a terminal device operated by the user. Otherwise, for example, a printed-out two-dimensional code may be used.

FIG. 9 is a drawing illustrating an example configuration of information acquired from the two-dimensional code. FIG. 9 illustrates an example of information necessary to access the file server 14. The information of FIG. 9 includes, for example, the unique ID and the address of the file server 11, an ID which is used when the relay server 11 is used, and a link which is used for activation.

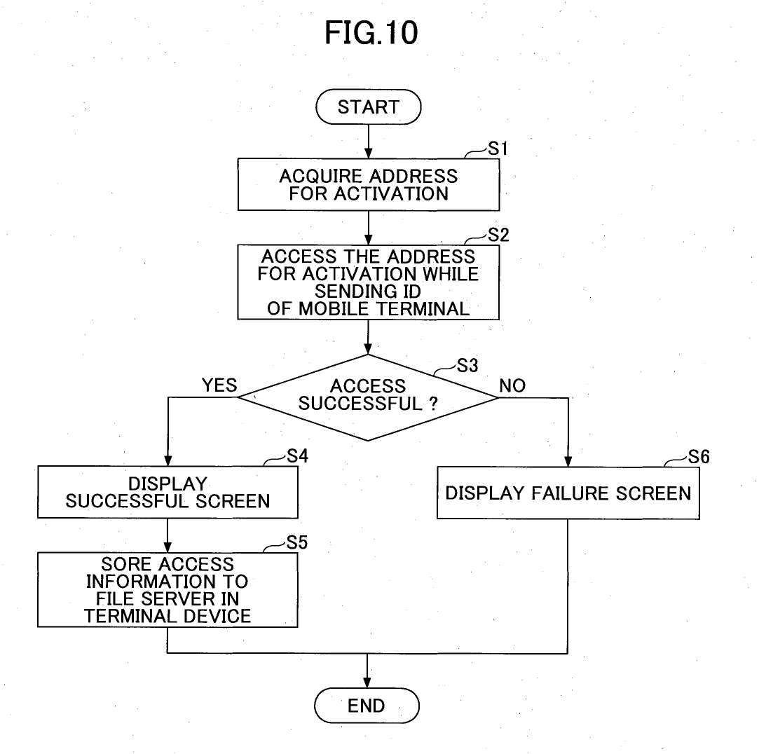

FIG. 10 is a flowchart of an example of a smart device registration process. In step S1, the smart device 13 acquires the link, which is to be used for activation, as illustrated in FIG. 9, and which is read from, for example, the two-dimensional code of FIG. 7.

In step S2, the smart device 13 accesses the link to be used for activation (i.e., the address for the activation) while transmitting the smart device ID of the smart device 13.

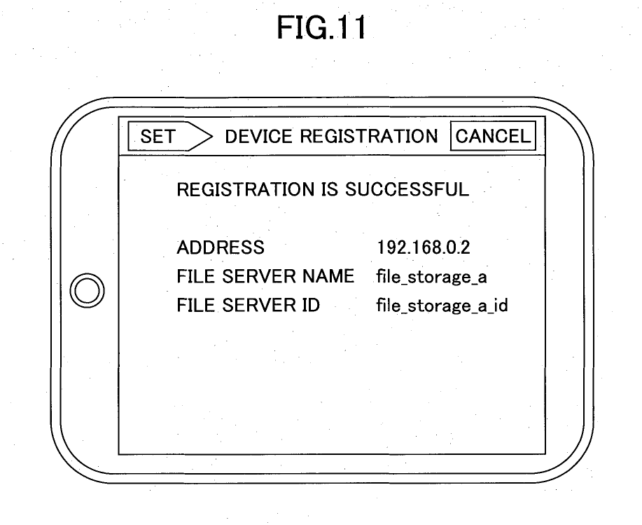

In step S3, after accessing the file server 14 using the link to be used for the activation, the smart device 13 determines whether the smart device 13 is registered in the file server 14. In step S4, when accessing the file server 14 using the link to be used for the activation and determining that the smart device 13 is registered in the file server 14, the smart device 13 displays a successful screen as illustrated in FIG. 11.

FIG. 11 is a conceptual drawing of an example successful screen. The successful screen of FIG. 11 indicates that the registration of the smart device 13 has been successful, and displays the IP address of the file server 14 that has registered the smart device 13, the file server name, and the file server ID. After step S4, the process goes to step S5, where the smart device 13 stores the information necessary to access the file server 14 (access information to the file server 14). When the registration in the file server 14 has failed in step S3, the process goes to step S6, where the smart device 13 displays a failure screen which indicates that the registration in the file server 14 has failed.

The flowchart of FIG. 10 illustrates a process in which the activation is performed based on the address for the activation acquired from the two-dimensional code, the information of the smart device 13 is registered in the file server 14, and information of the file server 14 is registered in the smart device 13.

The file serve 14 does not permit access from the smart device 13 that has not performed the smart device registration process of FIG. 10. In a case where it is necessary for a smart device 13 to use the file server 14, it is necessary for the smart device 13 to perform the smart device registration process in advance. The smart device 13 having performed the smart device registration process can acquire information and a file stored in the file server 14.

### Group Generation

In the information processing system 1 according to an embodiment, it is necessary to generate a group to which conversation content of chat is to be transmitted. For example, the information processing system 1 generates a group to which conversation content of chat is to be transmitted as described below.

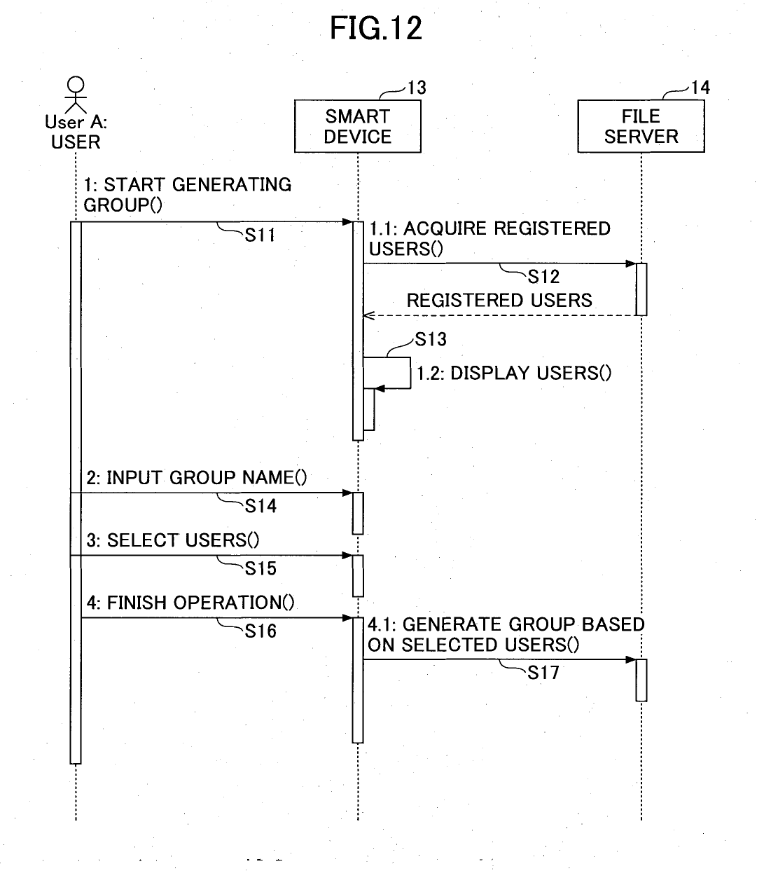

FIG. 12 is a sequence diagram of an example of a group generation process. In step S11, a user who operates the smart device 13 instructs the smart device 13 to start generating a group. The process goes to step S12, where the smart device 13 sends a request to the file server 14 to acquire information indicating registered users who can participate in chat. In response to the request, the file server 14 transmits the information of the registered users to the smart device 13.

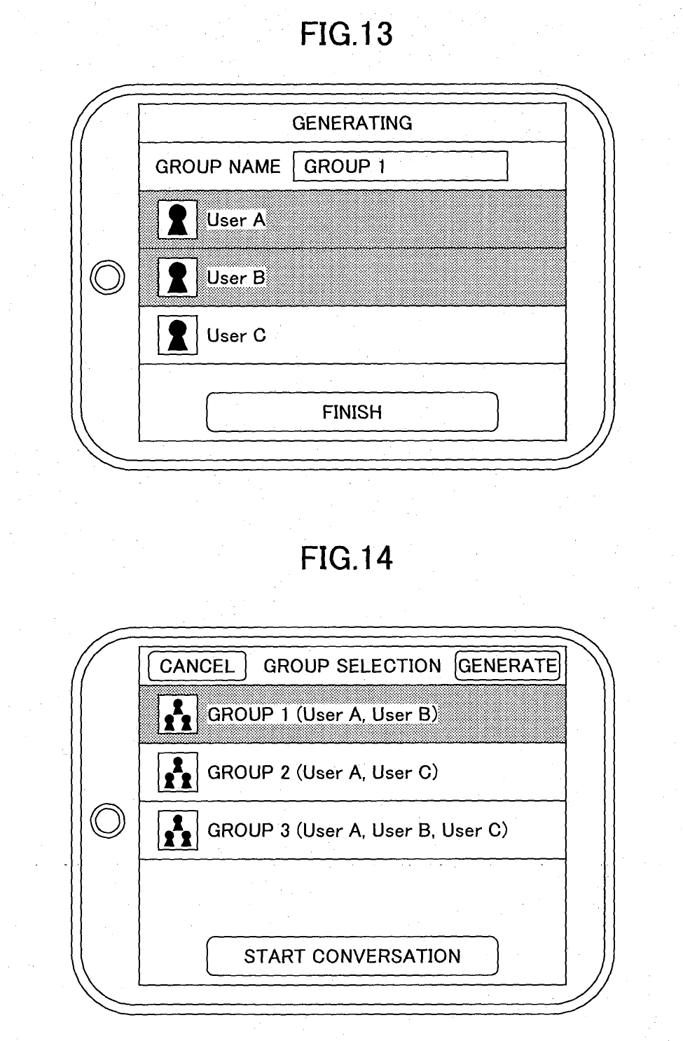

In step S13, the smart device 13 displays a group generation screen as illustrated in FIG. 13 by using the information of the registered users. FIG. 13 is a conceptual drawing of an example of a group generation screen. The group generation screen is an example of a screen which is displayed on the smart device 13 to generate a group. The group generation screen of FIG. 13 includes a column to input a group name and columns to select users.

In step S14, a user operates the smart device 13 to input a group name in the group generation screen. Further, in step S15, the user operates the smart device 13 to select users who will participate in the group in the group generation screen. In step S16, the user operates the smart device 13 to finish the operation by pressing, for example, a “finish” button of the group generation screen.

When the user performs the finish operation, the process goes to step S17, where the smart device 13 sends a request to the file server 14 to generate the group by using the group name, which is input in step S14, and the users who are selected in step S15. Then, the file server 14, which receives the request to generate the group, generates the group by using the group name, which is input in step S14, and the users who are selected in step S15, and manages the group in association with the users.

### Chat Process

In the information processing system 1 according to an embodiment, chat is performed among the smart devices who are participating in the (same) group. FIG. 14 is a conceptual drawing of an example of a group selection screen to perform chatting. A user selects a group to perform chatting from the group selection screen as illustrated in FIG. 14, and presses the “start conversation” button. Here, the information of the groups to be displayed in the group selection screen is acquired from the file server 14. When the “start conversation” button is pressed, the smart device 13 notifies the chat server 12 of the group to perform chatting selected from the group selection screen.

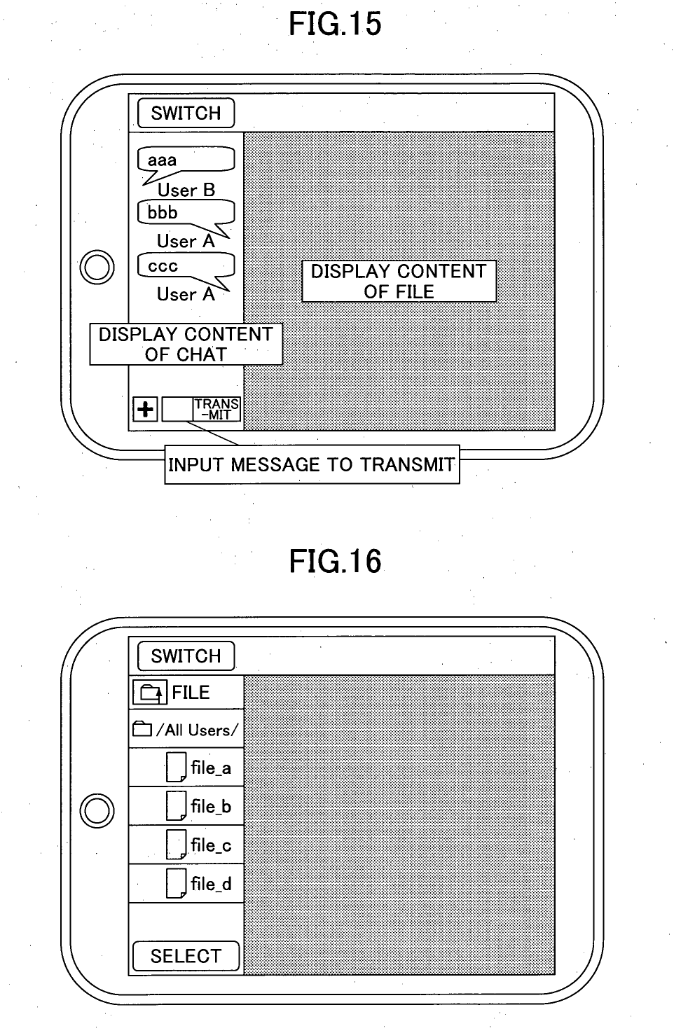

The smart device 13, which is operated by a user of the group to perform chatting, displays a chat screen as illustrated, for example, in FIG. 15. FIG. 15 is a conceptual drawing of an example of the chat screen.

On the left side of the chat screen of FIG. 15, there is an area (a part) where the conversation content of chat is displayed. On the lower part of the area where the conversation content of chat is displayed, a box is disposed where a message to be transmitted is input. On the right side of the chat screen of FIG. 15, the content of the selected file is displayed as described below.

When the “switch” button on the upper side of the chat screen of FIG. 15 is pressed, the smart device 13 acquires a list of the files from the file server 14, and displays a file selection screen as illustrated in FIG. 16. FIG. 16 is a conceptual drawing of an example of the file selection screen.

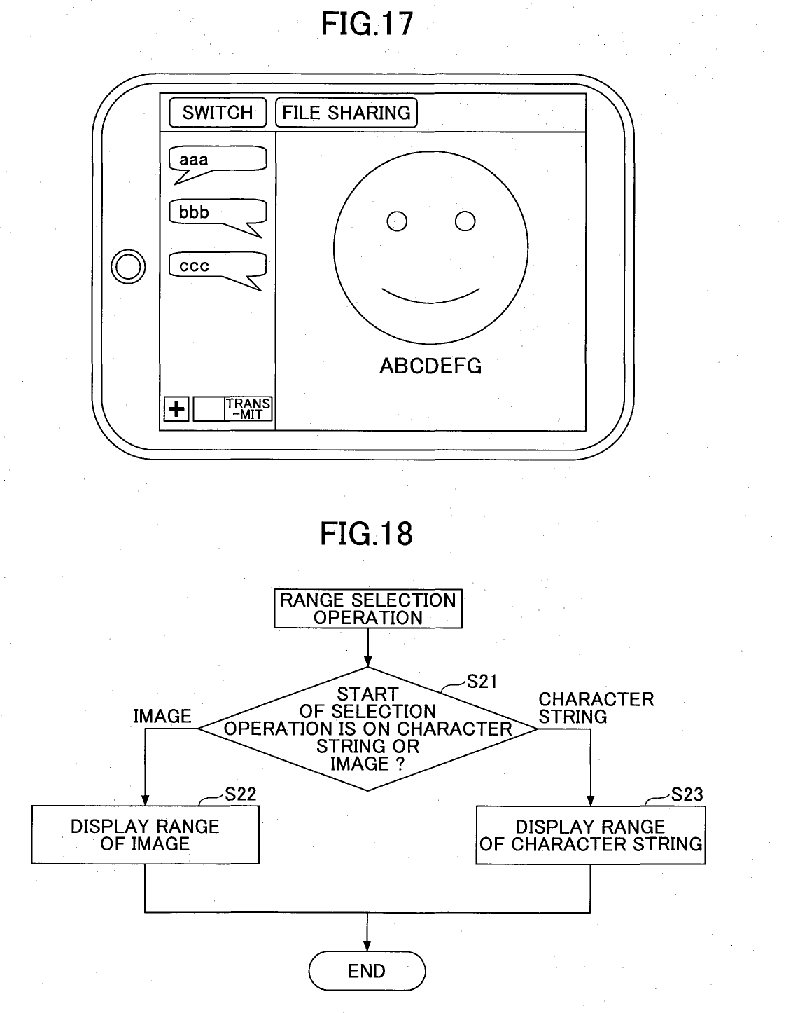

On the left side of the file selection screen of FIG. 16, a list of the files is displayed. A user selects a file whose content is to be displayed from the list of the files displayed in the file selection screen, and presses the “select” button. When the file is selected from the list, the smart device 13 acquires the selected file from the file server 14, and displays the chat screen as illustrated in FIG. 17.

FIG. 17 is a conceptual drawing of an example of the chat screen displaying the content of the file. The chat screen of FIG. 17 illustrates a case where the content of the file selected from the file selection screen of FIG. 16 is displayed on the right side of the chat screen of FIG. 15.

For example, on the upper side of the chat screen of FIG. 17, there is a “file sharing” button to share the display of the content of the file among the smart devices 13 operated by the users in the (same) group. When the “file sharing” button is pressed, the smart device 13 notifies the other smart devices 13 operated by the users in the group of the file whose content is being displayed, so that it becomes possible to share the display of the content of the file. Further, besides the “file sharing” button, the smart device 13 may further notify the other smart devices 13 operated by the users in the group of the link to the file whose content is being displayed as a message.

In the chat screen of FIG. 17 where the content of the file is displayed, the user can perform a range selection operation in the content of the file. FIG. 18 is a flowchart of an example of the range selection operation.

By performing the range selection operation in a part where the content (image) of the file is displayed in the chat screen of FIG. 17 displaying the content of the file by the user, the display section 21 of the smart device 13 displays a selection range described below. As examples of the range selection operation, there are an operation to draw a circle with a finger, an operation to touch for a longer period, etc.

When a user performs the range selection operation, the smart device 13 performs difference processes depending on whether a start point of the range selection operation by the user is on a character string or on an image in step S21 of FIG. 18.

When it is determined that the start point of the range selection operation by the user is on an image, the process goes to step S22, where the selection range of the image is displayed. On the other hand, when it is determined that the start point of the range selection operation by the user is on a character string, the process goes to step S23, where the selection range of the character string is displayed.

Further, it is assumed that the file selected in this embodiment refers to a file described in an electronic document format such as PDF, etc., where an image and a character string can be distinguished from each other or a file described in a format of an application. In the following, the process to proceed to step S22 and the process to proceed to step S23 in FIG. 18 are separately described.

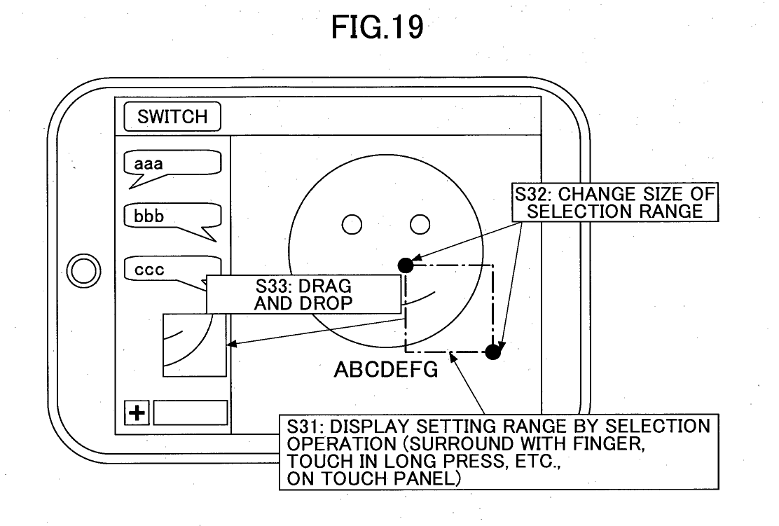

FIG. 19 is a conceptual drawing of an example of the process to proceed to step S22. In step S21, the display section 21 of the smart device 13 determines that the start point of the range selection operation performed by a user is on an image, and displays the selection range of the image. Here, the selection range of the image includes pointers which are to change the size and the position of the selection area. In step S32, the display section 21 receives the change of the selection range from the user.

In step S33, the display section 21 receives an operation by the user to add (append) the selection range of the image to the part where the conversation content of chat is displayed (e.g., a drag-and-drop operation). By the operation by the user of adding the selection range of the image to the part where the conversation content of chat is displayed, the display section 21 displays the selection range of the image in the part where the conversation content of chat is displayed. As illustrated in FIG. 19, the user can select a part of the image of the file and display the part of the image in the part where the conversation content of chat is displayed.

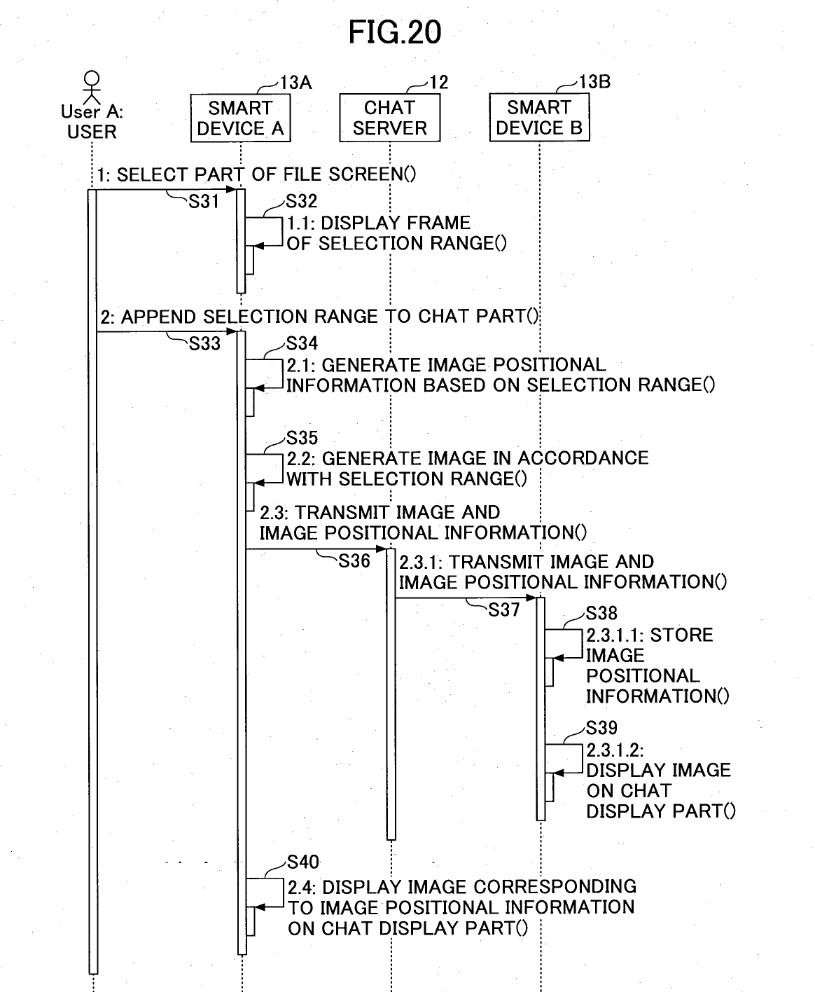

When the start point of the range selection operation performed by a user is on an image, the information processing system 1 according to this embodiment performs a process, for example, as illustrated in FIG. 20. FIG. 20 is an example sequence diagram when the start point of the range selection operation is on an image.

In step S31, a user operates the smart device 13A to perform the range selection operation on the image. In step S32, for example, the display section 21 of the smart device 13A displays a frame of the selection range of the image as illustrated in FIG. 19. In step S33, the user performs a process of adding the selection range of the image to the area where the conversation content of chat is displayed.

In step S34, the information generation section 24 of the smart device 13A generates image positional information of the partial image based on the selection range of the image on which the adding is performed to the part where the conversation content of chat is displayed. Further, in step S35, the image generation section 25 of the smart device 13A generates an image corresponding to the image positional information (“partial image”).

In step S36, the data transmission section 27 of the smart device 13A transmits the image positional information and the partial image to the chat server 12. The chat server 12 determines the group in chat to which the received image positional information and the partial image are to be transmitted.

In step S37, the chat server 12 distributes the image positional information and the partial image, which are received from the smart device 13A, to, for example, a smart device 13B operated by a user of the group in chat. In step S38, the data receiving section 28 of the smart device 13B receives the image positional information and the partial image from the chat server 12. The file management section 29 stores the received image positional information and the partial image.

In step S39, the display section 21 of the smart device 13B displays the received partial image in the part where the conversation content of chat is displayed. Further, in step S40, the display section 21 of the smart device 13A displays the image (partial image) corresponding to the image positional information in the part where the conversation content of chat is displayed (“chat display part”).

As described above, the information processing system 1 according to this embodiment can use a part of the image of the file in chat by displaying the part of the image of the file in the area where the conversation content of chat is displayed.

Here, with reference to the sequence diagram of FIG. 20, a case is described where the generation of the image corresponding to the image positional information is performed by the information generation section 24 of the smart device 13A. However, for example, the file server 14 may generate the image corresponding to the image positional information. In this case, the smart device 13A transmits the image positional information to the file server 14 along with a request to generate the partial image, so that the file server 14 generates the partial image corresponding to the image positional information.

The file server 14, which generates the partial image may transmit the partial image to the smart device 13A that sends the request to generate the partial image or may transmit the partial image to the chat server 12. In a case where the partial image is transmitted to the smart device 13A, the process of and after step S36 in FIG. 20 is performed. On the other hand, in a case where the partial image is transmitted to the chat server 12, in place of the process of steps S36 and S37, the image positional information and the partial image are transmitted from the chat server 12 to the smart device 13 operated by the user of the group in chat.

In FIG. 20, a case is described where the partial image in the chat display part of the smart device 13B is displayed earlier than in the partial image in the chat display part of the smart device 13A. However, it does not matter whichever displays the partial image earlier.

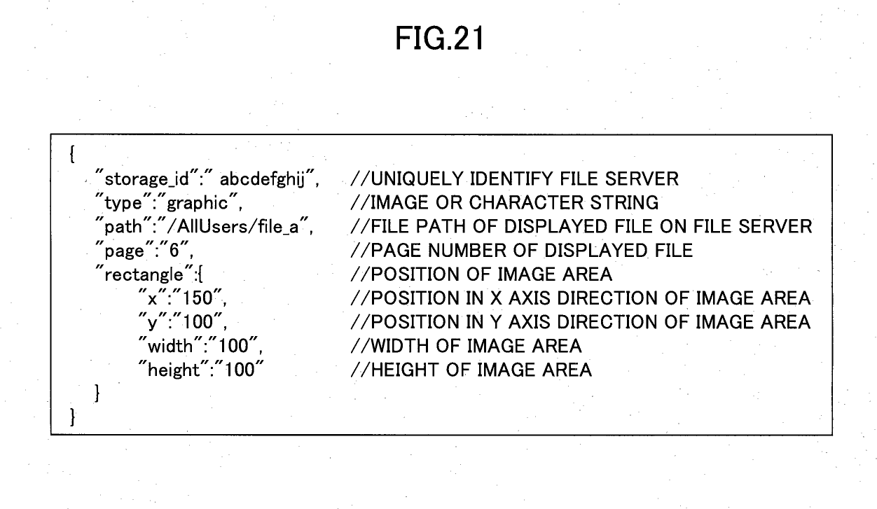

The image positional information generated in step S34 has, for example, a configuration as illustrated in FIG. 21. FIG. 21 is a drawing illustrating an example configuration of the image positional information. The image positional information of FIG. 21 can be broadly divided into two types of information: the information to identify the image of the file, and the information to identify the position of the partial image.

The information to identify the image of the file includes information to uniquely identify the file server 14, information to distinguish between image and character string, and a file path and a page number of the file, which are being displayed, on the file server 14. On the other hand, the information to identify the position of the partial image includes the position in the X axis direction of the partial image, the position in the Y axis direction of the partial image, the width of the partial image, and the height of the partial image.

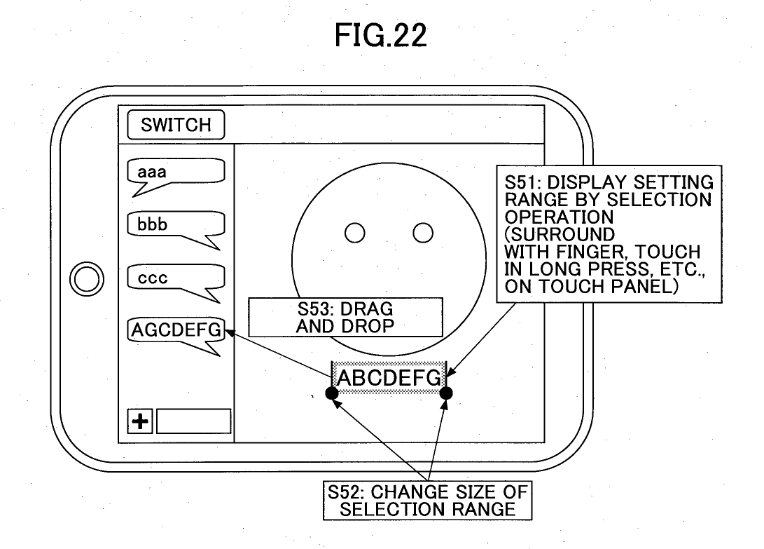

FIG. 22 is a conceptual drawing of an example of a process to proceed to step S23. In step S51, the display section 21 of the smart device 13 determines that the start point of the range selection operation performed by a user is on a character string, and displays the selection range of the character string. Here, in the selection range of the character string, there are provided points which are to change the selection range. In step S52, the display section 21 receives an input to change the selection range of the character string from a user.

In step S53, the display section 21 receives an operation by the user to add (append) the selection range of the character string to the part where the conversation content of chat is displayed (e.g., the drag-and-drop operation).

By the operation by the user of adding the selection range of the character string to the part where the conversation content of chat is displayed, the display section 21 displays the selection range of the character string in the part where the conversation content of chat is displayed. As illustrated in FIG. 22, the user can select a part of the character string of the file and display the part of the character string in the part where the conversation content of chat is displayed.

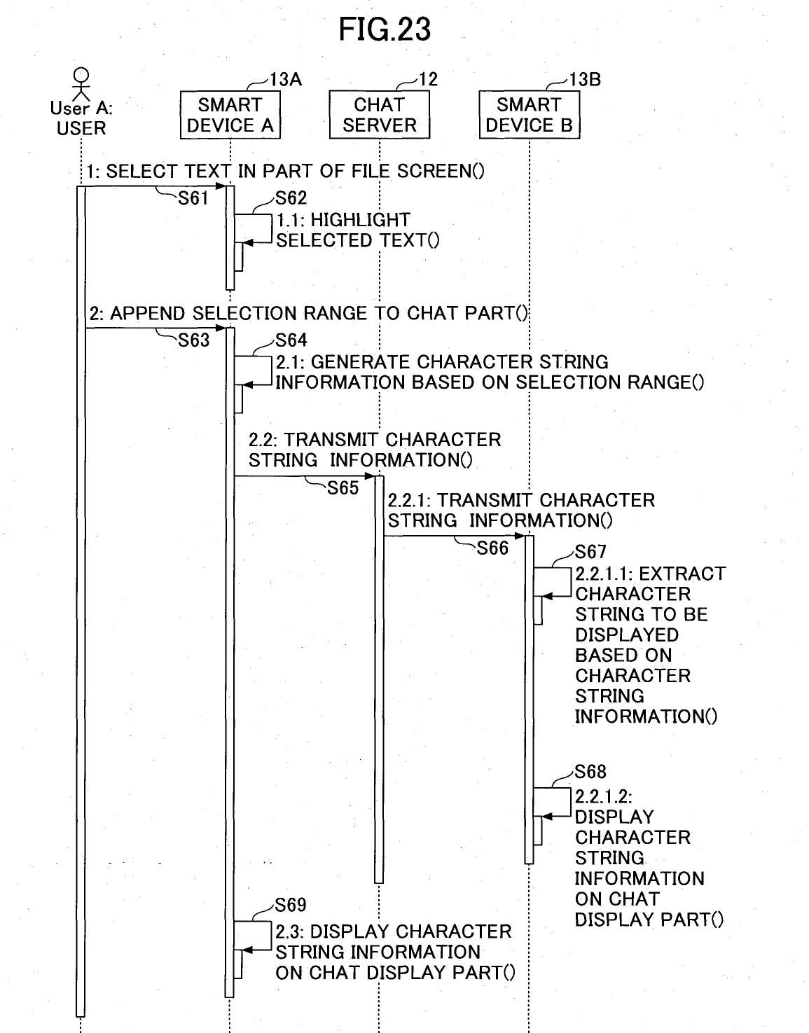

When the start point of the range selection operation performed by a user is on a character string, the information processing system 1 according to this embodiment performs a process, for example, as illustrated in FIG. 23. FIG. 20 is an example sequence diagram when the start point of the range selection operation is on a character string.

In step S61, a user operates the smart device 13A to perform the range selection operation on the character string. In step S62, for example, the display section 21 of the smart device 13A highlights the selection range of the character string as illustrated in FIG. 22.

In step S63, the user performs a process of adding the selection range of the character string to the area where the conversation content of chat is displayed. In step S64, the text information generation section 30 of the smart device 13A generates character string information based on the selection range of the character string on which the adding is performed to the part where the conversation content of chat is displayed.

In step S65, the data transmission section 27 of the smart device 13A transmits the character string information to the chat server 12. The chat server 12 determines the group in chat to which the received character string information is to be transmitted.

In step S66, the chat server 12 distributes the character string information, which is received from the smart device 13A, to, for example, the smart device 13B operated by a user of the group in chat. In step S67, the data receiving section 28 of the smart device 13B receives the character string information from the chat server 12. The file management section 29 stores the received character string information. Further, the display section 21 of the smart device 13B extracts the character string to be displayed based on the received character string information.

In step S68, the display section 21 of the smart device 13B displays the character string, which is extracted from the character string information, in the part where the conversation content of chat is displayed. Further, in step S69, the display section 21 of the smart device 13A displays the character string corresponding to the character string information in the part where the conversation content of chat is displayed (“chat display part”).

As described above, the information processing system 1 according to this embodiment can use a part of the character in chat by displaying the part of the character string of the file selected by the user in the part where the conversation content of chat is displayed.

In FIG. 23, a case is described where the character string in the chat display part of the smart device 13B is displayed earlier than in the partial image in the chat display part of the smart device 13A. However, it does not matter whichever displays the partial image earlier.

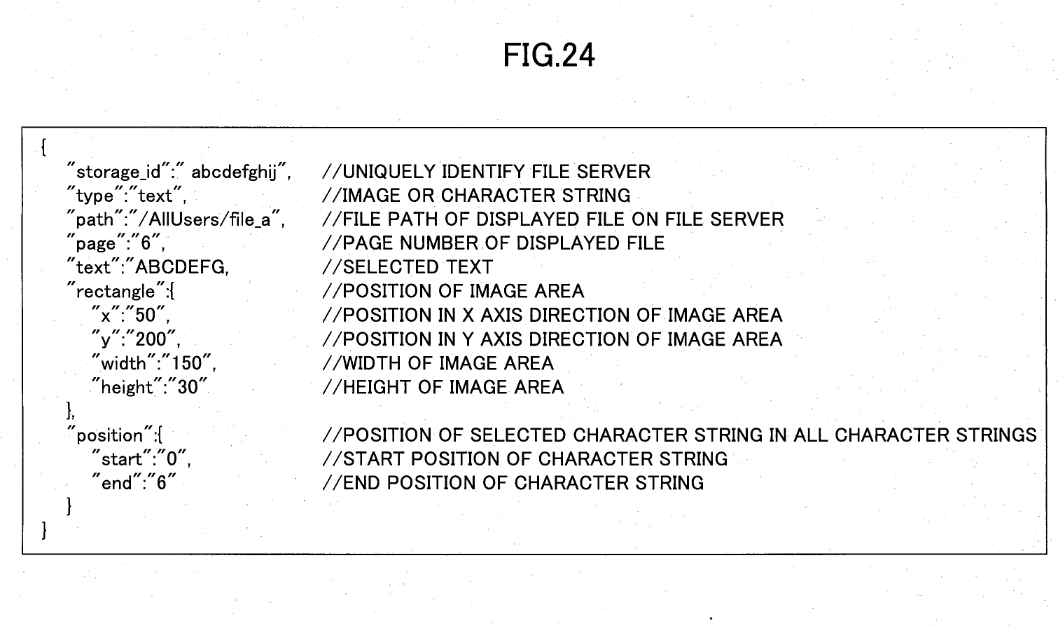

The character string information generated in step S64 has, for example, a configuration as illustrated in FIG. 24. FIG. 24 is a drawing illustrating an example configuration of the character string information. The character string information of FIG. 24 can be broadly divided into four types of information: the information to identify the image of the file, the selected character string, the information to identify the position of the character string, and the information to identify the position of the character string relative to all the character strings.

The information to identify the image of the file includes information to uniquely identify the file server 14, information to distinguish between image and character string, and a file path and a page number of the file, which is being displayed, on the file server 14. The information to identify the position of the character string includes the position in the X axis direction of the character string, the position in the Y axis direction of the character string image, the width of the character string, and the height of the character string. The information to identify the position of the character string relative to all the character strings includes the start position of the character string, and the end position of the character string. Therefore, it is possible to change the display of the file by using the character string information.

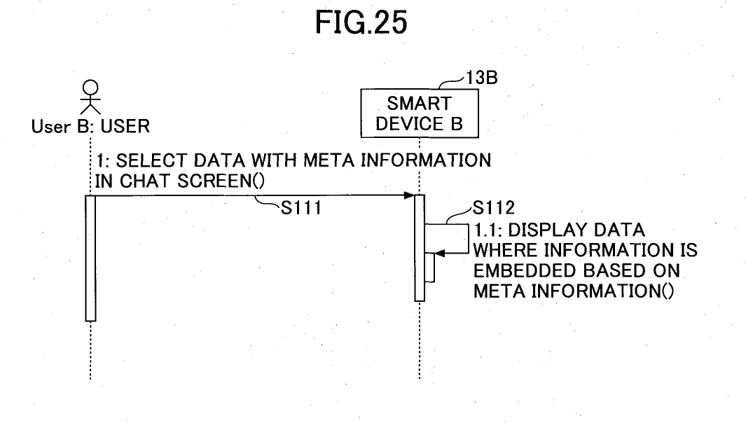

FIG. 25 is a sequence diagram of a process when a character string, which is displayed as a hyperlink in a chat area, is selected.

For example, the display section of the smart device 13A displays a received character string “AGCDEFG” as a hyperlink. The character string “AGCDEFG” displayed as a hyperlink includes the character string information described above as meta information.

In step S111, by selecting a character string displayed as a hyperlink in the chat area, the user who operates the smart device 13B can acquire the character string information stored as the meta information of the character string.

In step S112, the display section 21 of the smart device 13B can open the file included in the character string based on the information to identify the image of the file, and highlight-display the character string selected by the user included in the content of the opened file in accordance with the acquired character string information. If the file is already open, it is sufficient that the character string selected by the user is highlight-displayed.

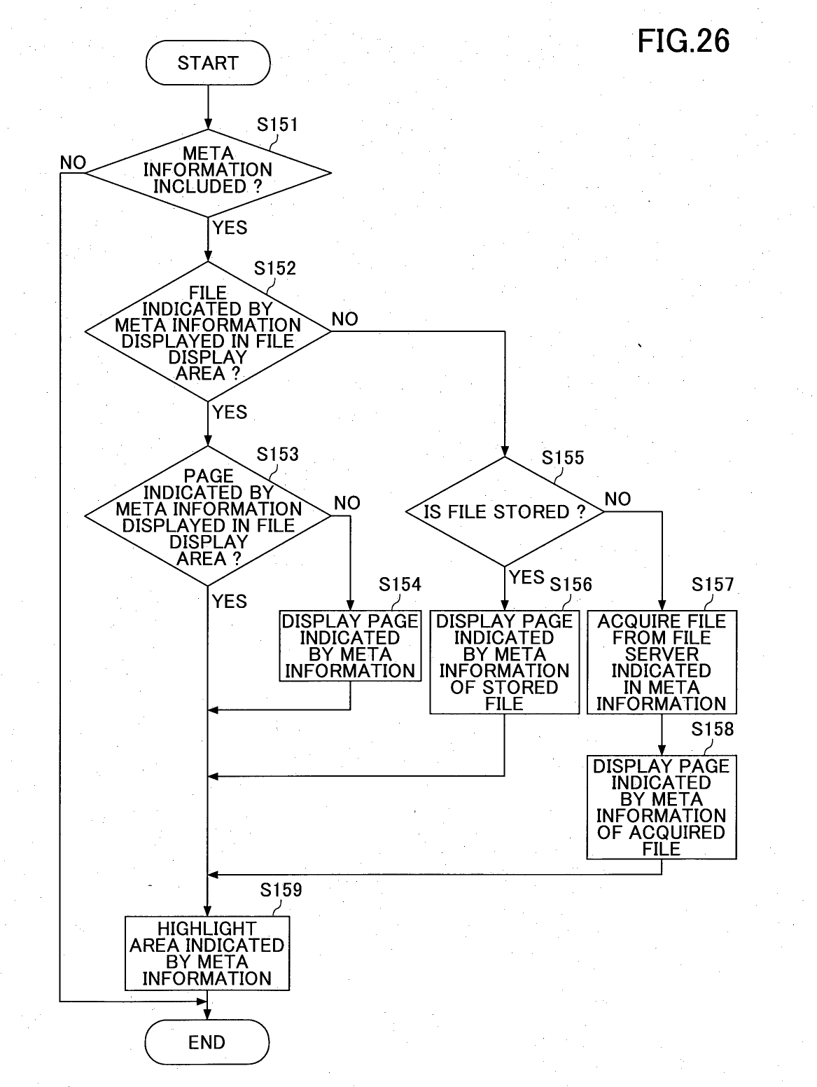

Further, FIG. 26 illustrates a process which is executed by the smart device 13B when a user selects the information (a message) in a chat area.

First, the smart device 133 determines whether the selected message includes meta information (information of the area selected by the smart device 13A) (step S151). When determining that meta information is included (YES in step S151), the smart device 13B further determines whether a file indicated by the meta information is displayed in a file display area (step S152). Here, whether the file is displayed is determined based on a comparison between the meta information illustrated in FIGS. 21 and 24 and the information of the file displayed on the smart device 13B (e.g., a file path on an acquired file server or a file server of the displayed file, a page number of the file, etc.). On the other hand, when determining that meta information is not included (NO in step S151), the smart device 13B executes a normal operation which is to be executed when the message is selected (e.g., copying a character string, displaying a button of a selection range, downloading a file, etc.).

When determining that a file indicated by the meta information is displayed in a file display area (YES in step S152), the smart device 13B further determines whether a page indicated by the meta information is displayed in the file display area (step S153). When determining that a page indicated by the meta information is displayed in the file display area (YES in step S153), the smart device 13B highlights the area indicated by the meta information based on the positional information of the meta information (step S159).

On the other hand, when determining that a file indicated by the meta information is not displayed in the file display area (NO in step S152), the smart device 13B further determines whether the file indicated by the meta information is stored in the smart device 13B (step S155). When determining that the file indicated by the meta information is stored in the smart device 13B (YES in step S155), the smart device 13B displays a page indicated by the meta information of the stored file (step S156), and highlights the area indicated by the meta information (step S159). On the other hand, when determining that the file indicated by the meta information is not stored in the smart device 13B (NO in step S155), the smart device 13B acquires the file, which is indicated by the meta information, from the file server indicated by the meta information (step S157), displays the page indicated by the meta information of the acquired file (step S158), and highlights the area indicated by the meta information (step S159).

Further, when determining that a page indicated by the meta information is not displayed in the file display area (NO in step S153), the smart device 13B displays the page indicated by the meta information (step S154), and highlights the area indicated by the meta information (step S159).

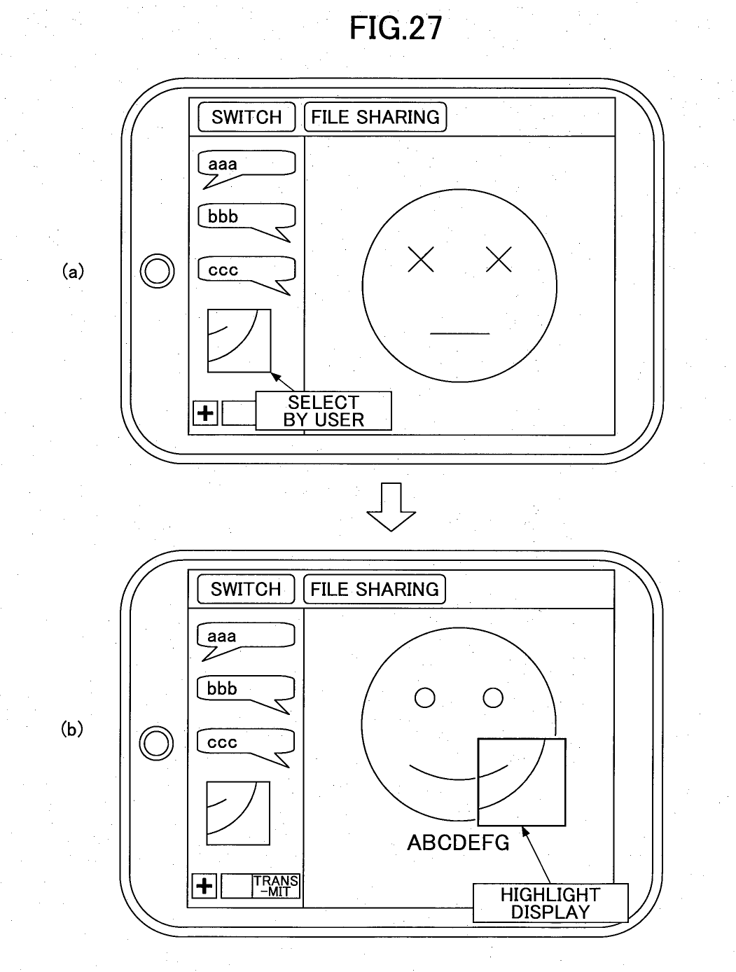

Further, FIG. 27 illustrates example screens when the smart device 13B opens a file which is different from the file indicated by the meta information. As illustrated in part (a) of FIG. 27, when a user selects a message including the meta information of the chat area (the area where the message is displayed), the file indicating the meta information is displayed and the area indicating the meta information is highlighted as illustrated in part (b) of FIG. 27.

By doing this, it becomes possible for a user B to easily know the part of the file indicated by a user A.

Note that the process illustrated in FIG. 25 may be applied to not only the character string information but also the image positional information. Further, note that the display of the selected part is not limited to the highlighting. An arrow may be used to point the selected part, or the selected part may be turned on and off.

### Another System Configuration

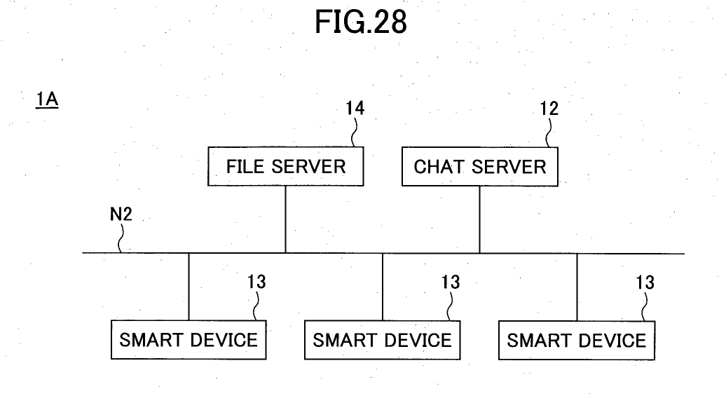

The configuration of the information processing system 1 of FIG. 1 is one example only. For example, the information processing system 1 according to an embodiment may have another configuration as illustrated in FIG. 28. FIG. 28 is a drawing of another example of the information processing apparatus according to an embodiment.

An information processing system 1A includes the chat server 12, a plurality of smart devices 13, and the file server 14, which are connected to the network N2 such as a LAN. There are no communications over the FW 15 in the information processing system 1A of FIG. 28, so that the relay server 11 is omitted (removed). Even in the information processing system 1A of FIG. 28, it is possible to perform the processing similar to that of the information processing system 1 as described above. Note that, in the information processing system 1A of FIG. 28, the chat server 12 and file server 14 may be integrated (unified).

### SUMMARY

According to an embodiment of the present invention, it becomes possible to visibly share the partial images and character strings among the users who are participating in chat by displaying the content of chat and the content of the file and adding the partial image and the character string of the file to a part where the content of chat is displayed. Therefore, according to an embodiment, it becomes possible for users who are participating in chat to easily make a comment and point out by chat on the partial image and the character string of the file which are visibly shared among the users.

According to an embodiment, it becomes possible to coordinate the functions provided by the file server 14 and the functions provided by the chat server 12 to work together in the smart device 13.

Note that the present invention is not limited to the embodiments described above, and various modifications and changes may be made without departing from a scope of the present invention. Here, the file server 14 is an example of claimed “file storage unit”. The chat server 12 is an example of a “distribution unit”. The display section 21 is an example of a “display unit”. The data transmission section 27 is an example of a “transmission unit”. The information generation section 24 is an example of an “image information generation unit”.

The image generation section 25 is an example of an “image generation unit”. The text information generation section 30 is an example of a “character string information generation unit”. The operation receiving section 22 is an example of an “operation receiving unit”. The file server 14 is an example of the “file storage unit”. The chat server 12 is an example of the “distribution unit”.

Note that embodiments of the present invention do not limit the scope of the present invention. Namely, the present invention is not limited to the configurations as illustrated in FIGS. 1 and 26. For example, the information processing systems 1 and 1A may be provided by using one or more information processing apparatuses, so that the functions may be arbitrarily divided among the apparatuses as long as those functions as described above can be realized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

The present application is based on and claims the benefit of priority of Japanese Patent Application Nos. 2014-007277 filed Jan. 17, 2014, and 2015-000719 filed Jan. 6, 2015, the entire contents of which are hereby incorporated herein by reference.

### DESCRIPTION OF THE REFERENCE NUMERALS

1: INFORMATION PROCESSING SYSTEM
11: RELAY SERVER
12: CHAT SERVER
13: SMART DEVICE
14: FILE SERVER
15: FIREWALL (FW)
21: DISPLAY SECTION
22: OPERATION RECEIVING SECTION
23: TWO-DIMENSIONAL CODE READ SECTION
24: IMAGE INFORMATION GENERATION SECTION
25: IMAGE GENERATION SECTION
26: SETTING STORAGE SECTION
27: DATA TRANSMISSION SECTION
28: DATA RECEIVING SECTION
29: FILE MANAGEMENT SECTION
30: TEXT INFORMATION GENERATION SECTION
41: DATA TRANSMISSION SECTION
42: DATA RECEIVING SECTION
43: USER GROUP MANAGEMENT SECTION
44: DATA TRANSMISSION DESTINATION DETERMINATION SECTION
51: DATA RECEIVING SECTION
52: DATA STORAGE SECTION
53: REQUEST RECEIVING SECTION
54: DATA DETERMINATION SECTION
55: DATA TRANSMISSION SECTION
61: DATA TRANSMISSION SECTION
62: DATA RECEIVING SECTION
63: USER GROUP MANAGEMENT SECTION
64: FILE MANAGEMENT SECTION
65: LOG MANAGEMENT SECTION
66: REQUEST INQUIRY SECTION
67: REQUEST PROCESSING SECTION
100: COMPUTER
101: INPUT DEVICE
102: DISPLAY DEVICE
103: EXTERNAL I/F
103A: RECORDING MEDIUM
104: RAM
105: ROM
106: CPU
107: COMMUNICATION I/F
108: HDD
B: BUS
N1, N2: NETWORK

### PRIOR ART DOCUMENTS

### Patent Document

[Patent Document 1] Japanese Laid-open Patent Publication No. 2013-161481

1. An information processing system comprising:
one or more information processing apparatuses; and
two or more terminal devices, including first and second terminal devices, which are connected to the one or more information processing apparatuses,
wherein each of the information processing apparatuses includes
a storage unit configured to store a file, and
a first transmission unit configured to, in response to a request from one of the terminal devices, transmit the file stored in the storage unit to the one of the terminal devices,
wherein the first terminal device includes
an acquisition unit configured to send the request to the one or more information processing apparatuses to acquire the file stored in the storage unit, and acquire the file,
a first display unit including first and second display areas, the first display area being configured to display the file acquired by the acquisition unit, the second display area being configured to display messages transmitted to and received from the second terminal device,
a reception unit configured to receive a selection of a certain area of the file displayed in the first display area by the first display unit and an operation to transmit the certain area as one of the messages transmitted to and received from the second terminal device, and
a second transmission unit configured to transmit a message, which includes information indicating the certain area received by the reception unit, to the second terminal device,
wherein the second terminal device includes
a second display unit including first and second display areas, the first display area being configured to display the file, the second display area being configured to display messages transmitted to and received from the first terminal device, and
wherein the second display unit is configured to display the message, which includes the information indicating the certain area and is transmitted from the first terminal device, in the first display area, and, upon receiving a selection of the displayed message, display the file based on the information indicating the certain area included in the displayed message.

2. The information processing system according to claim 1,
wherein the second terminal device further includes
a second acquisition unit configured to acquire the file from the one or more information processing apparatuses when the file indicating the information of the certain area is not displayed in the first display area of the second display unit, and
wherein the second display unit is configured to display the acquired file in the first display area of the second display unit.

3. The information processing system according to claim 1,
wherein the first terminal device further includes
an image information generation unit configured to generate image positional information, which indicates a selection range of the file displayed by the first display unit, based on the selection of the certain area of the file displayed in the first display area, the selection being received by the reception unit; and
an image generation unit configured to generate an image based on the image positional information, and
wherein the second transmission unit is configured to transmit the image positional information and the image as the selection range of the file displayed by the first display unit to the second terminal device.

4. The information processing system according to claim 3,
wherein the image positional information includes information identifying the image of the file displayed by the first display unit and information identifying the position of the selection range of the file displayed by the first display unit.

5. The information processing system according to claim 1,
wherein the first terminal device further includes
a character string information generation unit configured to generate character string information, which indicates a selection range of the file displayed by the first display unit, based on the selection of the certain area of the file displayed in the first display area, the selection being received by the reception unit, and
wherein the second transmission unit is configured to transmit the character string information as the selection range of the file displayed by the first display unit to the second terminal device.

6. The information processing system according to claim 5,
wherein the character string information includes information identifying the image of the file displayed by the first display unit, a selected character string, and information identifying the position of the selected character string.

7. The information processing system according to claim 1,
wherein the second display unit is configured to display the message in the first display area, the message including the information indicating the certain area and being transmitted from the first terminal device, and, upon receiving the selection of the displayed message, and display the file and highlight the area indicating the information of the certain area based on the information of the certain area included in the message.

8. The information processing system according to claim 1,
wherein the second transmission unit is configured to transmit the information, which is received from the first terminal device, to the second terminal device, which is operated by a user who is participating in a same group as that of a user who operates the first terminal device, by using a chat function.

9. An information processing system comprising:
two or more terminal devices including first and second terminal devices,
wherein the first terminal device includes
an acquisition unit configured to send a request to an information processing apparatus, which is connected to the information processing system, storing a file in a storage unit, and acquire the file,
a first display unit including first and second display areas, the first display area being configured to display the file acquired by the acquisition unit, the second display area being configured to display messages transmitted to and received from the second terminal device,
a reception unit configured to receive a selection of a certain area of the file displayed in the first display area by the first display unit and an operation to transmit the certain area as one of the messages transmitted to and received from the second terminal device, and
a first transmission unit configured to transmit a message, which includes information indicating the certain area received by the reception unit, to the second terminal device,
wherein the second terminal device includes
a second display unit including first and second display areas, the first display area being configured to display the file, the second display area being configured to display messages transmitted to and received from the first terminal device, and
wherein the second display unit is configured to display the message, which includes the information indicating the certain area and is transmitted from the first terminal device, in the first display area, and, upon receiving a selection of the displayed message, display the file based on the information indicating the certain area included in the displayed message.
